(19) United States
(12) Patent Application Publication
(10) Pub. No.: US 2026/0243922 A1
(43) Pub. Date: Aug. 20, 2026

(54) Line Pattern Projector Incorporating One or More Metasurfaces

(71) Applicant: Metalenz, Inc., Boston, MA (US)

(72) Inventors: Pawel Latawiec, Chicago, IL (US); Mohammad Salary, San Francisco, CA (US)

(73) Assignee: Metalenz, Inc., Boston, MA (US)

(21) Appl. No.: 19/161,133

(22) PCT Filed: Feb. 29, 2024
(86) PCT No.: PCT/US24/17901

§ 371 Date: Aug. 29, 2025

Related U.S. Application Data
(60) Provisional application No. 63/487,768, filed on Mar. 1, 2023.

(51) Int. Cl. G02B 1/00

(52) U.S. Cl. CPC G02B 1/00

(57) ABSTRACT

Line pattern projectors may include metasurface devices. In one particular example, a line pattern projector includes: a light source configured to output light; and a metasurface device separated from the light source by a distance, where the metasurface device is configured to receive the output light from the light source and transform the light into a line pattern.

### CROSS-REFERENCE TO RELATED APPLICATIONS

This application claims the benefit of and priority under 35 U.S.C. § 119(e) to U.S. Provisional Patent Application Ser. No. 63/487,768, entitled “Line Pattern Projector Incorporating One or More Metasurfaces” and filed Mar. 1, 2023, which is incorporated herein by reference in its entirety for all purposes.

### FIELD OF THE INVENTION

The present invention generally relates to line pattern projectors incorporating one or more metasurfaces.

### BACKGROUND

Metasurface elements are diffractive optical elements in which individual waveguide elements have subwavelength spacing and have a planar profile. Metasurface elements have recently been developed for application in the UV-IR bands (300-10,000 nm). Compared to traditional refractive optics, metasurface elements abruptly introduce phase shifts onto light field. This enables metasurface elements to have thicknesses on the order of the wavelength of light at which they are designed to operate, whereas traditional refractive surfaces have thicknesses that are 10-100 times (or more) larger than the wavelength of light at which they are designed to operate. Additionally, metasurface elements may have no variation in thickness in the constituent elements and thus are able to shape light without any curvature, as typically included in refractive optics. Compared to traditional diffractive optical elements (DOEs), for example binary diffractive optics, metasurface elements have the ability to impart a range of phase shifts on an incident light field, at a minimum the metasurface elements can have phase shifts between 0-2π with at least 5 distinct values from that range, whereas binary DOEs are only able to impart two distinct values of phase shift and are often limited to phase shifts of either 0 or 1π. Compared to multi-level DOE's, metasurface elements do not require height variation of its constituent elements along the optical axis, only the in-plane geometries of the metasurface element features vary.

### SUMMARY OF THE DISCLOSURE

In some aspects, the techniques described herein relate to a line pattern projector including: a light source configured to output light; and a metasurface device separated from the light source by a distance, wherein the metasurface device is configured to receive the output light from the light source and transform the light into a line pattern.

In some aspects, the techniques described herein relate to a line pattern projector, wherein the distance includes a back focal length of the metasurface device.

In some aspects, the techniques described herein relate to a line pattern projector, wherein the light source includes a vertical-cavity surface-emitting laser (VCSEL) array.

In some aspects, the techniques described herein relate to a light pattern projector, wherein the metasurface includes a refractive sub-optic and a diffractive sub-optic and wherein the refractive sub-optic projects and/or collimates perpendicular to lines of the line pattern and blurs along the lines of the line pattern.

In some aspects, the techniques described herein relate to a line pattern projector, wherein the diffractive sub-optic extends the field of illumination along a horizontal direction while setting the intensity profile of the lines of the line pattern.

In some aspects, the techniques described herein relate to a line pattern projector, wherein the metasurface device includes a substrate with a metasurface positioned on one surface of the substrate.

In some aspects, the techniques described herein relate to a line pattern projector, wherein the surface of the substrate that the metasurface is positioned on directly faces the light source.

In some aspects, the techniques described herein relate to a line pattern projector, wherein the metasurface is positioned on a surface of the substrate facing the light source such that light from the light source is diffracted by the metasurface and the diffracted light passes through the substrate.

In some aspects, the techniques described herein relate to a line pattern projector, wherein the metasurface includes one dimensional supercells.

In some aspects, the techniques described herein relate to a line pattern projector, wherein the metasurface is positioned on a surface of the substrate opposite to the light source such that light from the light source passes through the substrate and then is diffracted by the metasurface.

In some aspects, the techniques described herein relate to a line pattern projector, wherein the line pattern includes solid, dashed, and/or dotted lines.

In some aspects, the techniques described herein relate to a line pattern projector, wherein the metasurface device includes a plurality of pillars, wherein pillars in adjacent columns include a different diameter.

In some aspects, the techniques described herein relate to a line pattern projector, wherein pillars in the same column have the same diameter as at least one adjacent pillar in the same column.

In some aspects, the techniques described herein relate to a line pattern projector, wherein the line pattern has an intensity which is uniform.

In some aspects, the techniques described herein relate to a line pattern projector, wherein the line pattern has a batwing intensity distribution which is higher at the edges.

In some aspects, the techniques described herein relate to a line pattern projector, wherein the line pattern has line width of 0.1 to 3 degrees.

In some aspects, the techniques described herein relate to a line pattern projector, wherein the line pattern has a field of illumination between 50 degrees and 150 degrees.

In some aspects, the techniques described herein relate to a line pattern projector, wherein the metasurface device has elliptical contours which make up an elliptical lens which includes overlapping repeating elliptical patterns positioned along one direction.

### BRIEF DESCRIPTION OF THE DRAWINGS

The description will be more fully understood with reference to the following figures, which are presented as exemplary embodiments of the invention and should not be construed as a complete recitation of the scope of the invention, wherein:

FIG. 1 is a line pattern projector incorporating a metalens or metasurface optic in accordance with an embodiment of the invention.

FIG. 2 is a schematic for a line pattern projector in accordance with an embodiment of the invention.

FIG. 3A is an example VCSEL array layout in accordance with an embodiment of the invention.

FIG. 3B is an example output from the metasurface device after illumination from the VCSEL array of FIG. 3A.

FIG. 3C is a graph of intensity profile of the lines of FIG. 3A at the center of the line pattern showing an almost uniform intensity in angle.

FIG. 4A is another example VCSEL array layout which includes 8 rows and 8 columns in accordance with an embodiment of the invention.

FIG. 4B is an example output from the metasurface device after illumination from the VCSEL array of FIG. 4A.

FIG. 4C is a graph of intensity profile of the lines at the center of the line pattern showing batwing profile with higher intensity at the edges of the field.

FIG. 5A illustrates an example equation for the functionality of the metasurface of FIG. 1.

FIG. 5B is an example of a line pattern projector with a tilted metasurface.

FIGS. 6A and 6B schematically show the method for formation of each line in the line pattern in accordance with various embodiments of the invention.

FIG. 7 is an image of an example phase function across the metasurface corresponding to the refractive sub-optic forming the line pattern which is described by an elliptical lens function.

FIG. 8 is an image of an example phase function across the metasurface corresponding to the diffractive sub-optic forming the line pattern which features a periodic pattern with abrupt variations along the Y-direction while being invariant along the X-direction leading to a one-dimensional supercell structure.

FIG. 9 is an example microscopic structure for the metasurface of FIG. 1 showing distribution of pillars at different length scales.

### DETAILED DESCRIPTION

Various embodiments of the present disclosure relate to a line pattern projector incorporating one or more metasurfaces and methods of designing thereof. In some embodiments, the line pattern projector may include a single metasurface chip or optical component. Line pattern projectors may be utilized for machine vision and learning, LiDAR (light detection and ranging) and SLAM (simultaneous localization and mapping) by flying objects (drones), autonomous vehicles and robots. Various embodiments include a single metasurface on top of a light source with a distance between the metasurface and the light source. The light source may be a vertical-cavity surface-emitting laser (VCSEL) array or one or more other lasers, LEDs, or light sources, including arrays of LEDs or arrays of lasers. The distance between the metasurface and the light source may be a back focal length (BFL) of the metasurface.

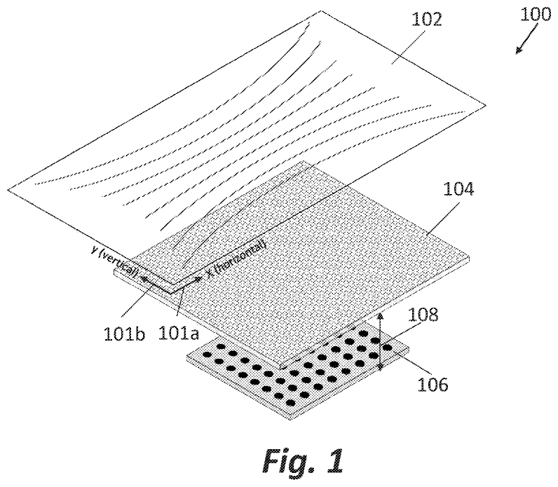

Turning to the figures, FIG. 1 is a line pattern projector 100 incorporating a metalens or metasurface optic in accordance with an embodiment of the invention. The line pattern projector 100 includes a metasurface device 104 which is spaced apart from a VCSEL array 106 by a distance 108. The distance 108 may be a BFL distance. The metasurface device 104 may combine a refractive sub-optic with a diffractive sub-optic, wherein the sub-optic functions are designed and incorporated into a single metasurface. In some embodiments, the metasurface device 104 may combine a refractive sub-optic with a single diffractive sub-optic. The VCSEL array 106 illuminates the metasurface device 104 which refracts and/or diffracts the light from the VCSEL array to illuminate a scene with a line pattern 102. The metasurface device 104 may collimate and project the light emitting from each row of the VCSEL array 106 into one line such that individual lines in the line pattern can be turned on or off by individual addressing of VCSEL array rows. The projected lines may be turned on in sequence, in various combinations of lines or all at the same time. In some embodiments, the VCSEL array and metasurface device may be mounted in a horizontal or vertical orientation, or any orientation between horizontal and vertical depending on the application. The metasurface device 104 may include one dimensional supercells with periodicity along the lines of the line pattern 102 which may be modulated according to the collimation/projection function from center of the metasurface toward the edges. Supercells are discussed in Int. Pub. No. WO 2021/226544, entitled “Wavelength tunable metasurface based external cavity laser” and filed May 7, 2021, which is hereby incorporated by reference in its entirety. For example, WO 2021/226544 discloses the supercell is directly parametrized and simulated and used as the basic element of a metasurface that can implement different beam patterns in different directions (e.g., different grating orders). The geometry of the supercell can be arbitrary, as opposed to a sequence of predetermined cells. Because the primitive element of this type of metasurface can be a supercell instead of a single subwavelength cell, this class of metasurfaces can be referred to as a metasurface based on supercells.

In the metasurface device 104, the refractive sub-optic may project and/or collimate the emission perpendicular to lines of the line pattern 102 and blur the emission along the lines of the line pattern 102. As illustrated, the line pattern 102 may include a plurality of lines which extend in an X-direction (horizontal direction) 101a. The plurality of lines are positioned such that adjacent lines are positioned in a Y-direction (vertical direction) 101b.

The diffractive sub-optics may extend the field of illumination along the horizontal direction setting the intensity profile of the lines of the line pattern 102 and replicating the lines projected for each row of the VCSEL array 106. Each row of the VCSEL array 106 can be projected into a single line or multiple lines of the line pattern 102. In the metasurface device 104, the diffracted sub-optics may further extend the field of illumination in the vertical direction in the case of mapping rows to multiple lines. The lines of the line pattern 102 can include solid, dashed, and/or dotted lines. Intensity along lines can be uniform or can have a distribution such as a batwing distribution (e.g. higher at the edges). The lines of the line pattern 102 may be straight, parallel, all curved, and/or equidistant at least through a central region. The line pattern 102 may be characterized with a linewidth, field of illumination, depth of field, line intensity profile, and contrast, as well as the number of lines. The linewidth may be 0.1 degrees to 3 degrees or 0.1 degrees to 2 degrees. The number of lines may be 1 or more, or 2-10 lines, or 8 lines to 56 lines or more. The field of illumination may be 50 degrees to 150 degrees.

As discussed the metasurface device 104 may include a refractive sub-optic component and a diffractive sub-optic component. The refractive sub-optic component may include a refractive phase function which may be an elliptical or cylindrical lens to perform collimation/projection along the Y-direction 101b and blurring along the X-direction 101a. The diffractive sub-optic component may include a diffractive phase function with abrupt variations to produce a weighted diffraction distribution along the X-direction 101a.

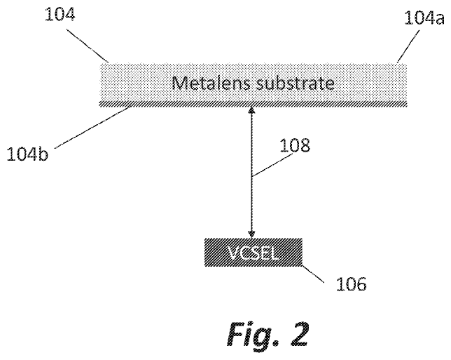

FIG. 2 is a schematic for a line pattern projector in accordance with an embodiment of the invention. The line pattern projector of FIG. 2 shares many identically numbered features with the line pattern projector of FIG. 1. The description of these features are applicable to the line pattern projector of FIG. 1 and will not be repeated in detail. The metasurface device 104 includes a metasurface substrate 104a with a metasurface 104b directly facing light source 106, although in alternative embodiments, the metasurface 104b could be on the opposite side of the substrate 104a from the light source 106, and in some embodiments the substrate thickness may be the BFL for the metasurface and the substrate may be in direct contact with the light source. In some embodiments the metasurface may be in direct contact with the light source.

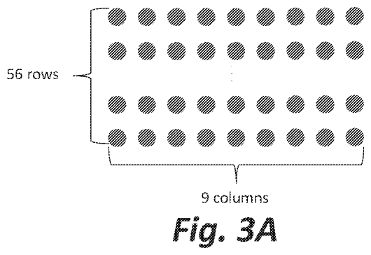

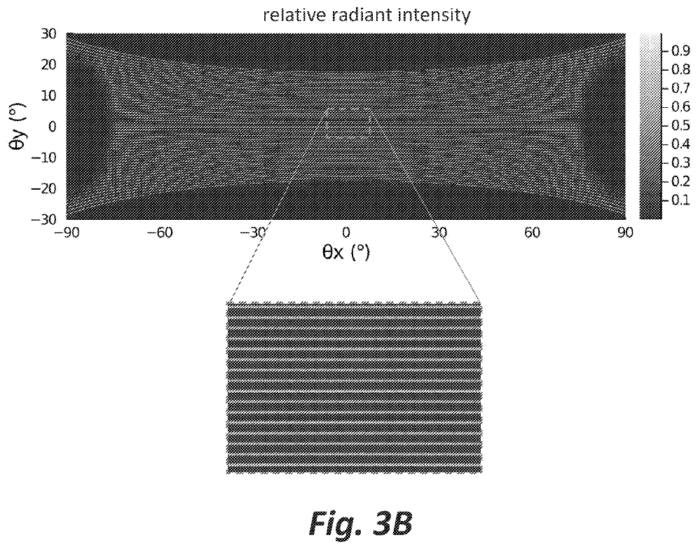

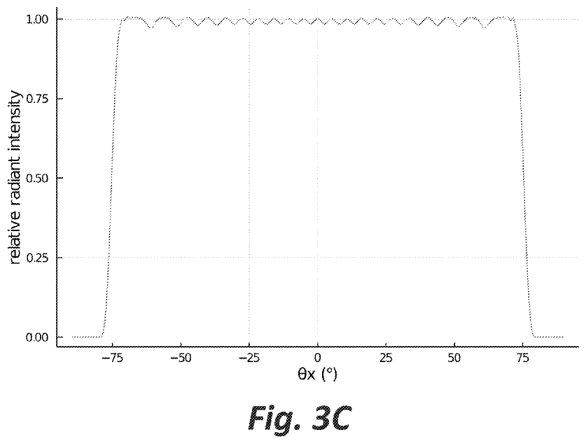

FIG. 3A is an example VCSEL array layout in accordance with an embodiment of the invention. The VCSEL array includes 56 rows and 9 columns. FIG. 3B is an example output from the metasurface device 104 after illumination from the VCSEL array of FIG. 3A. As illustrated, the metasurface device 104 produces a line pattern with uniform radiant intensity profile and 56 lines which match the 56 rows of the VCSEL array. The inset image is a magnified center portion of the line pattern which shows a pattern of horizontally extending repeating lines. FIG. 3C is a graph of intensity profile of the lines of FIG. 3A at the center of the line pattern showing an almost uniform intensity in angle.

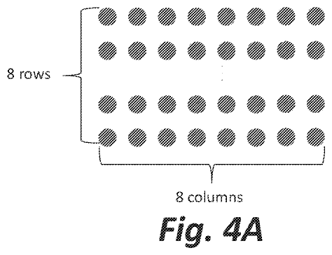

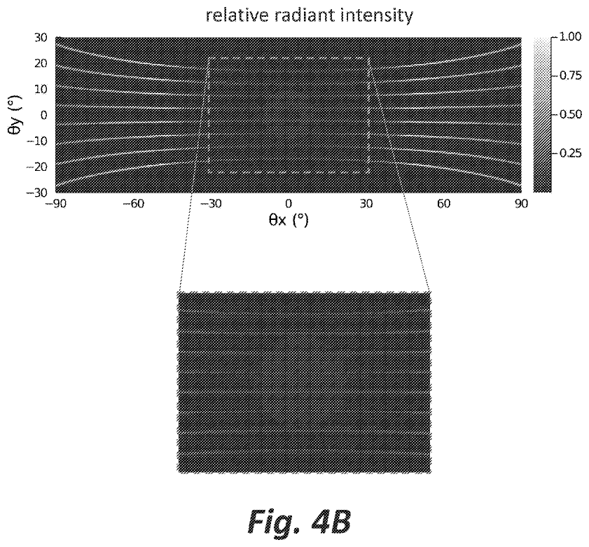

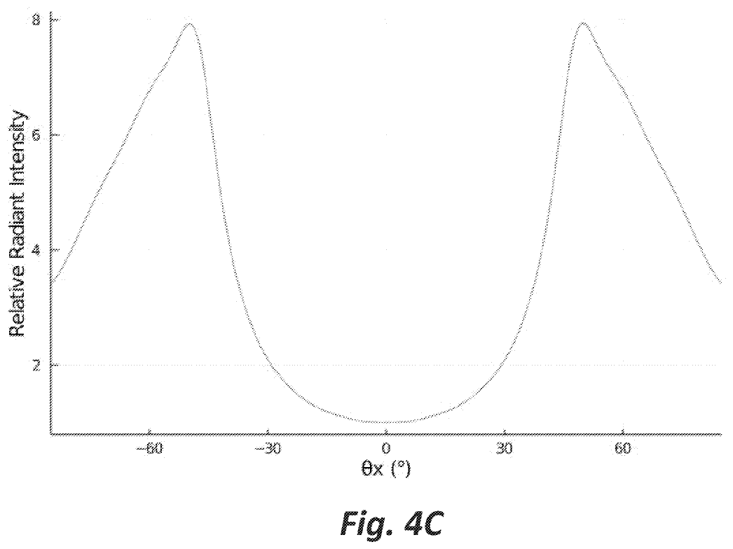

FIG. 4A is another example VCSEL array layout which includes 8 rows and 8 columns in accordance with an embodiment of the invention. FIG. 4B is an example output from the metasurface device 104 after illumination from the VCSEL array of FIG. 4A. As illustrated, the metasurface device 104 produces a line pattern with batwing radiant intensity profile and 8 lines matching the 8 rows of the VCSEL array. The inset image is a magnified center portion of the line pattern which shows a pattern of horizontally extending repeating lines, and an example in which the lines are largely parallel. FIG. 4C is a graph of intensity profile of the lines at the center of the line pattern showing batwing profile with higher intensity at the edges of the field.

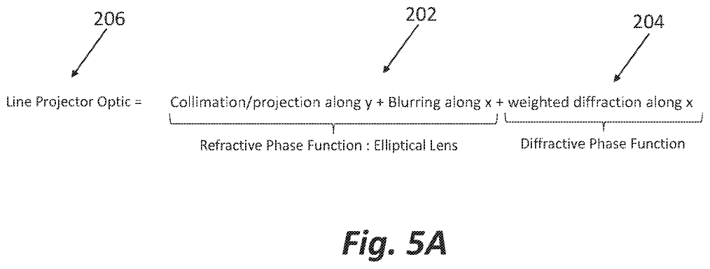

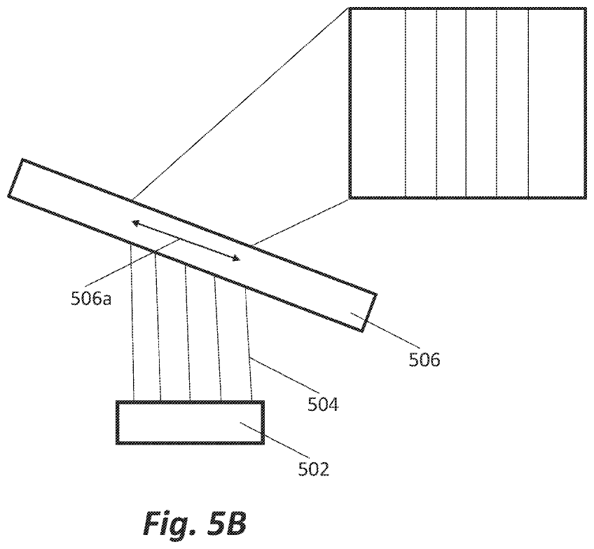

FIG. 5A illustrates an example equation for the functionality of the metasurface 104 of FIG. 1. As illustrated, a refractive phase function 202 may be an elliptical lens. A diffractive phase function 204 may be added to the refractive phase function to produce multiple lines in the line projector optic 206. In some embodiments, the refractive phase function may include a focus or focal point rather than being collimated. For example, the line projector may focus to a point relatively near the metasurface in order to illuminate near objects for machine learning or other near proximity viewing. In such cases, some embodiments may include an extended depth of focus in the image space. Such extended depth of focus of the illumination in the lines may be generated by including one or more aberrations in the refractive phase function to extend the length of the focal point along the optical or z-axis. Such aberrations may include one or more of: spherical aberration, coma, astigmatism, or any of the other known optical aberrations.

In some embodiments, a tilt may be added to the line pattern projector in order to alter the direction of the lines produced. For example, in a collimated set of lines for a metasurface that is perpendicular to a flat floor and travelling along that floor, the tilt may operate to direct the lines in a downward spread so that the lines extend out in front of the metasurface so that they land on the floor at different distances in front of the metasurface. In embodiments where the lines are not collimated but rather have a focal point or focal zone, such tilt may operate to alter the focal plane of the lines such that lines focus at different distances. For example, a tilt may produce lines that are closer to the metasurface plane on one side of the metasurface than the opposite side, or which produce lines that are focused at varying distances from the metasurface plane. A tilt may be included via a tilt or prism function in the metasurface design and/or via a tilt between the planes of the light source and the metasurface.

FIG. 5B is an example of a line pattern projector with a tilted metasurface. The line pattern projector may include a light source 502 which outputs collimated or near collimated light. The light source 502 may be a VCSEL. The light 504 from the light source 502 is incident on a tilted metasurface 506. The tilted metasurface 506 may include a tilt direction 506a. The tilted metasurface 506 may be tilted such that the output light is in a certain exposure direction. While a tilted metasurface 506 is illustrated, a prism may be included which may provide the same functionality as tilting the metasurface 506. The prism may be positioned before or after the metasurface such that the prism redirects the light and provides the redirected light onto the metasurface or the prism redirects light from the metasurface. In examples including a prism, the output from the metasurface 506 may be refracted in a certain exposure direction. In some embodiments, the metasurface may include a tilt component in the refractive lens component. In these examples, the metasurface itself may not be tilted but the metasurface may have a tilt component built into the design.

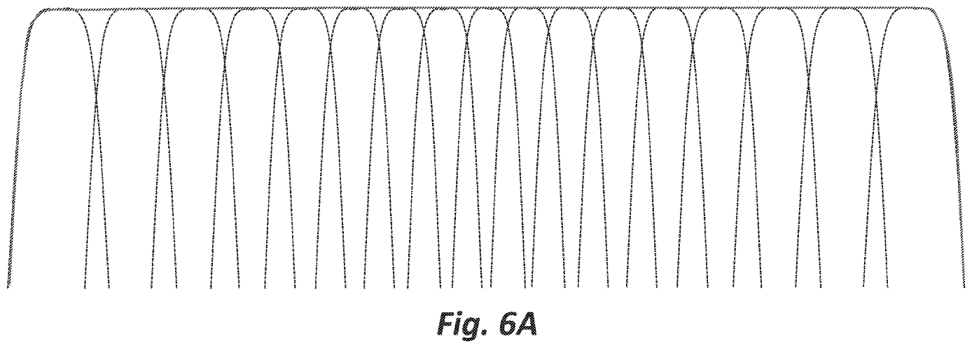

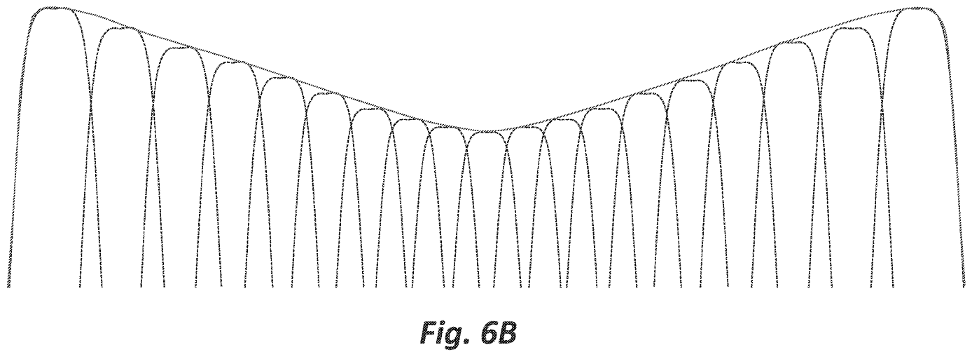

FIGS. 6A and 6B schematically show the method for formation of each line in the line pattern in accordance with various embodiments of the invention. The vertical dimension in these figures are the radiant intensity. As illustrated, each line is created by overlapping several smaller lines with smaller FOIS-denoted by dashed curves, having flat intensity in angle and customized weights determined by diffractive sub-optic such that their total adds up to the target intensity profile. FIG. 6A corresponds to a line with uniform radiant intensity while FIG. 6B corresponds to a line with batwing radiant intensity profile.

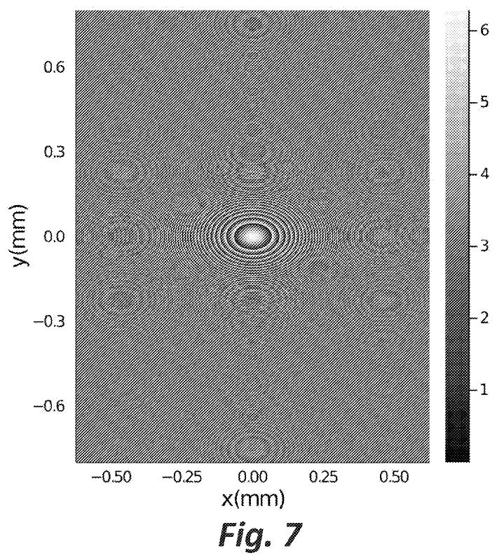

FIG. 7 is an image of an example phase function across the metasurface corresponding to the refractive sub-optic forming the line pattern which is described by an elliptical lens function.

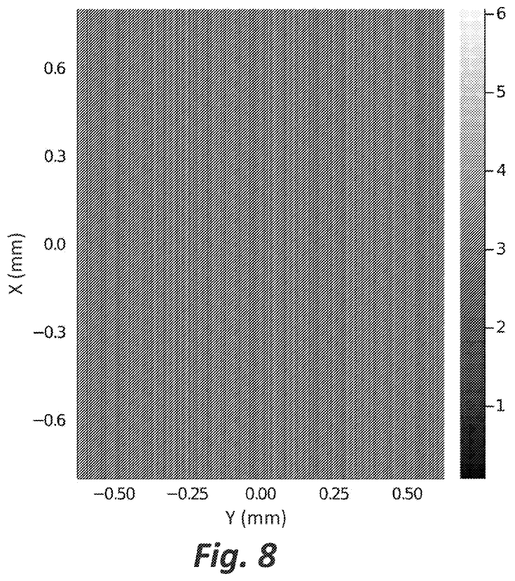

FIG. 8 is an image of an example phase function across the metasurface corresponding to the diffractive sub-optic forming the line pattern which features a periodic pattern with abrupt variations along the Y-direction while being invariant along the X-direction leading to a one-dimensional supercell structure.

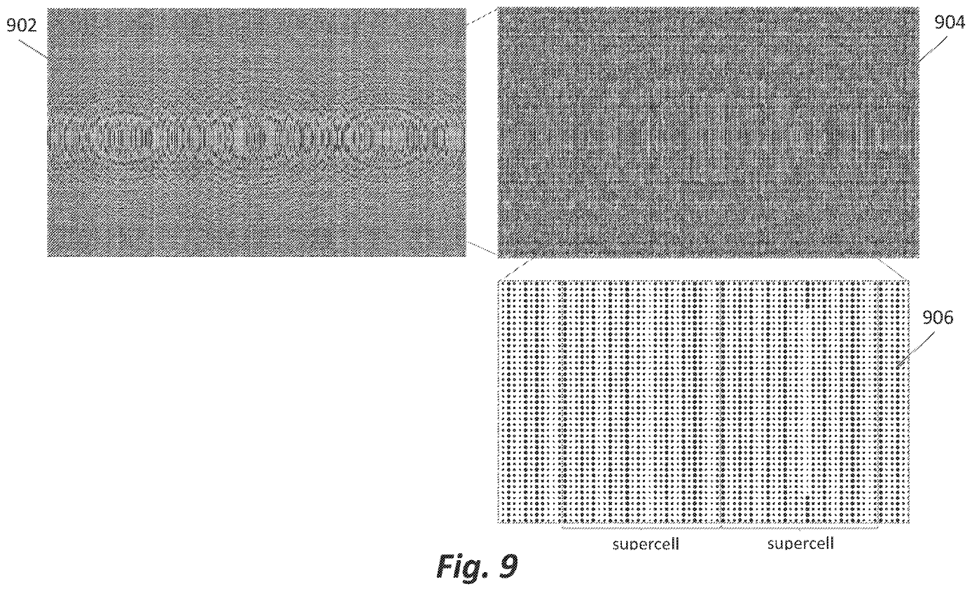

FIG. 9 is an example microscopic structure for the metasurface 104 of FIG. 1 showing distribution of pillars at different length scales. A first view 902 illustrates a zoomed out view of the pillars. A first inset image 904 of the first view is at larger length scales around the center of the metasurface. The macroscopic structure shows elliptical contours at the footprint of elliptical lens. There are overlapping repeating elliptical patterns positioned along one direction (e.g. the X-direction).

A second inset image 906 illustrates a magnified view of the structure at the center where the phase variations of the elliptical lens function are smooth. One-dimensional supercells correspond to the diffractive sub-optic. As illustrated, the one dimensional supercells are periodically repeating in the center of the metasurface 104. The metasurface 104 may be made up of cylindrical pillars with varying diameter. At the center, the elliptical lens is periodic. Moving away from the center, the periodicity is broken. In the center, the diameter of the cylindrical pillars are invariant along one direction (e.g. the Y-direction) and repeating along another (e.g. the X-direction). In some embodiments, there are at least 10 invariant diameter pillars in the Y-direction and however the diameter of the pillars varies every column in the X-direction. Elliptical lens may have different focal lengths along X-direction and Y-direction.

### Doctrine of Equivalents

While the above description contains many specific embodiments of the invention, these should not be construed as limitations on the scope of the invention, but rather as an example of one embodiment thereof. It is therefore to be understood that the present invention may be practiced in ways other than specifically described, without departing from the scope and spirit of the present invention. Thus, embodiments of the present invention should be considered in all respects as illustrative and not restrictive. Accordingly, the scope of the invention should be determined not by the embodiments illustrated, but by the appended claims and their equivalents.

What is claimed is:

1. A line pattern projector comprising:
a light source configured to output light; and
a metasurface device separated from the light source by a distance,
wherein the metasurface device is configured to receive the output light from the light source and transform the light into a line pattern.

2. The line pattern projector of claim 1, wherein the distance comprises a back focal length of the metasurface device.

3. The line pattern projector of claim 1, wherein the light source comprises a vertical-cavity surface-emitting laser (VCSEL) array.

4. The light pattern projector of claim 1, wherein the metasurface includes a refractive sub-optic and a diffractive sub-optic and wherein the refractive sub-optic projects and/or collimates perpendicular to lines of the line pattern and blurs along the lines of the line pattern.

5. The line pattern projector of claim 4, wherein the diffractive sub-optic extends the field of illumination along a horizontal direction while setting the intensity profile of the lines of the line pattern.

6. The line pattern projector of claim 1, wherein the metasurface device comprises a substrate with a metasurface positioned on one surface of the substrate.

7. The line pattern projector of claim 6, wherein the surface of the substrate that the metasurface is positioned on directly faces the light source.

8. The line pattern projector of claim 7, wherein the metasurface is positioned on a surface of the substrate facing the light source such that light from the light source is diffracted by the metasurface and the diffracted light passes through the substrate.

9. The line pattern projector of claim 6, wherein the metasurface includes one dimensional supercells.

10. The line pattern projector of claim 6, wherein the metasurface is positioned on a surface of the substrate opposite to the light source such that light from the light source passes through the substrate and then is diffracted by the metasurface.

11. The line pattern projector of claim 1, wherein the line pattern comprises solid, dashed, and/or dotted lines.

12. The line pattern projector of claim 1, wherein the metasurface device comprises a plurality of pillars, wherein pillars in adjacent columns include a different diameter.

13. The line pattern projector of claim 12, wherein pillars in the same column have the same diameter as at least one adjacent pillar in the same column.

14. The line pattern projector of claim 1, wherein the line pattern has an intensity which is uniform.

15. The line pattern projector of claim 1, wherein the line pattern has a batwing intensity distribution which is higher at the edges.

16. The line pattern projector of claim 1, wherein the line pattern has line width of 0.1 to 3 degrees.

17. The line pattern projector of claim 1, wherein the line pattern has a field of illumination between 50 degrees and 150 degrees.

18. The line pattern projector of claim 1, wherein the metasurface device has elliptical contours which make up an elliptical lens which includes overlapping repeating elliptical patterns positioned along one direction.
